(19) United States
(12) Patent Application Publication
(10) Pub. No.: US 2013/0133174 A1
(43) Pub. Date: May 30, 2013

(54) DRIVE PIN FOR SOIL REINFORCING CONNECTOR DEVICE

(71) Applicants: Thomas P. Taylor, Colleyville, TX (US); Timothy R. Griffin, Allegany, NY (US); Jose L. Gilarranz, Katy, TX (US)

(72) Inventors: Thomas P. Taylor, Colleyville, TX (US); Timothy R. Griffin, Allegany, NY (US); Jose L. Gilarranz, Katy, TX (US)

(73) Assignee: T & B STRUCTURAL SYSTEMS LLC, Ft. Worth, TX (US)

(21) Appl. No.: 13/307,732

(22) Filed: Nov. 30, 2011

(51) Int. Cl. B23P 11/00; F16B 21/00; F16B 19/02

(52) U.S. Cl. 29/525.01; 411/500; 411/360

(57) ABSTRACT

A drive pin mechanical fastener is disclosed and has an elongate body extending from a head. A frustoconical indicator shroud is disposed about the elongate body and has a first end and a second end. The first end of the indicator shroud is arranged about the elongate body proximate the head and the second end extends away from the head. The indicator shroud is movable from a first position, where the indicator shroud is frustoconical, to a second position, where the indicator shroud is flattened and exposed and thereby provides an indicator to an installer that the drive pin is properly installed.

### BACKGROUND

Retaining wall structures that use horizontally positioned soil inclusions to reinforce an earth mass in combination with a facing element are referred to as mechanically stabilized earth (MSE) structures. MSE structures can be used for various applications including retaining walls, bridge abutments, dams, seawalls, and dikes.

The basic MSE implementation is a repetitive process where layers of backfill and horizontally-placed soil reinforcing elements are positioned one atop the other until a desired height of the earthen structure is achieved. Typically, grid-like steel mats or welded wire mesh are used as soil reinforcing elements. In most applications, the soil reinforcing elements consist of parallel, transversely-extending wires welded to parallel, longitudinally-extending wires, thus forming a grid-like mat or structure. Backfill material and the soil reinforcing mats are combined and compacted in series to form a solid earthen structure, taking the form of a standing earthen wall.

In some applications, the soil reinforcing elements are attached or otherwise coupled to a substantially vertical wall either forming part of the MSE structure or offset a short distance therefrom. The vertical wall is typically made either of concrete or a steel wire facing and not only serves to provide tensile resistance to the soil reinforcing elements but also prevents erosion of the MSE structure. The soil reinforcing elements extend from the compacted backfill and are attached to the vertical wall in a variety of configurations. For instance, facing anchors can be embedded in the vertical wall and thereby provide a connection point where the soil reinforcing elements can be attached. Each facing anchor is typically positioned so as to correspond with and couple directly to an end of a soil reinforcing element.

A defective connection between the facing anchor and the soil reinforcing element will reduce the structural integrity of the MSE structure. Consequently, ensuring that the connection is secure is a vital step in making certain the MSE structure will be able to endure several years of effective use.

What is needed is a connection apparatus or device for connecting a soil reinforcing element to a facing anchor that readily indicates when a proper connection has been made.

### SUMMARY

Embodiments of the disclosure may provide a drive pin mechanical fastener. The drive pin mechanical fastener may include an elongate body extending from a head, and an indicator shroud having a first end and a second end, the first end being disposed about the elongate body proximate the head and the second end extending away from the head, the indicator shroud being movable from a first position, where the indicator shroud is frustoconical, to a second position, where the indicator shroud is flattened.

Embodiments of the disclosure may further provide a connection assembly for a soil reinforcing element. The connection assembly may include a facing anchor having first and second offset prongs, each prong having a hole defined therein, and a connection stud coupled to the soil reinforcing element and having a tab that defines a tab hole therein, the tab being positioned between the first and second prongs such that the tab hole may be concentrically-aligned with the holes in the first and second prongs. The connection assembly may also include a mechanical fastener having an elongate body extending from a head and through the holes defined in the prongs and the tab hole, and an indicator shroud having a first end and a second end, the first end being disposed about the body proximate the head of the mechanical fastener and the second end extending away from the head. The mechanical fastener may be configured to move from a first position, where the indicator shroud is frustoconical, to a second position, where the indicator shroud is flattened and extends radially-outward from the head such that the indicator shroud as flattened is visible from a top perspective.

Embodiments of the disclosure may further provide a method of securing a soil reinforcing element to a facing anchor. The method may include positioning a tab between first and second prongs of the facing anchor, the tab being coupled to the soil reinforcing element and having a tab hole defined therein, and aligning the tab hole with concentric holes defined in the first and second prongs. The method may also include inserting a drive pin body through the concentric holes of the first and second prongs and simultaneously through the tab hole, the drive pin body extending from a head and having a first series of teeth formed thereon adjacent the head, and forcing the drive pin body through the hole defined in the first prong such that the first series of teeth form an interference fit therein. The method may further include flattening an indicator shroud disposed about the drive pin body adjacent the head such that portions of the frustoconical indicator shroud are exposed radially-outward from the head and thereby provide a visual indication that the drive pin is properly secured.

Embodiments of the disclosure may further provide a drive pin mechanical fastener. The drive pin mechanical fastener may include an elongate body extending from a head and a sleeve at least partially encasing the elongate body. The drive pin mechanical fastener may also include a plurality of serrations defined at a distal end of the sleeve, such that the plurality of serrations are deformable, but resilient, such that the plurality of serrations are adapted to pass through one or more holes defined in a facing anchor and rebound to prevent the mechanical fastener from removal from the facing anchor.

Embodiments of the disclosure may further provide a drive pin mechanical fastener. The drive pin mechanical fastener may include an elongate body extending from a head, and a first series of teeth formed on the elongate body proximate the head and extending at least partially around a circumference of the elongate body, the first series of teeth having an outer diameter greater than a diameter of the elongate body and extending axially along an axial length of the body.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates an exploded perspective view of a soil reinforcing system, according to one or more embodiments disclosed.

FIGS. 2A and 2B illustrate side views of mechanical fasteners used to connect a soil reinforcing element to a facing anchor, according to one or more embodiments disclosed.

FIG. 3 illustrates a side view of the connection point shown in FIG. 1 where the mechanical fastener is in a first, unengaged position, according to one or more embodiments disclosed.

FIG. 4 illustrates a top view of the connection point shown in FIG. 3.

FIG. 5 illustrates a side view of the connection point shown in FIG. 3 where the mechanical fastener is in a second, engaged position, according to one or more embodiments disclosed.

FIG. 6 illustrates a top view of the connection point shown in FIG. 5.

FIG. 7 is a flowchart of a method of coupling a facing anchor to a connection stud, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

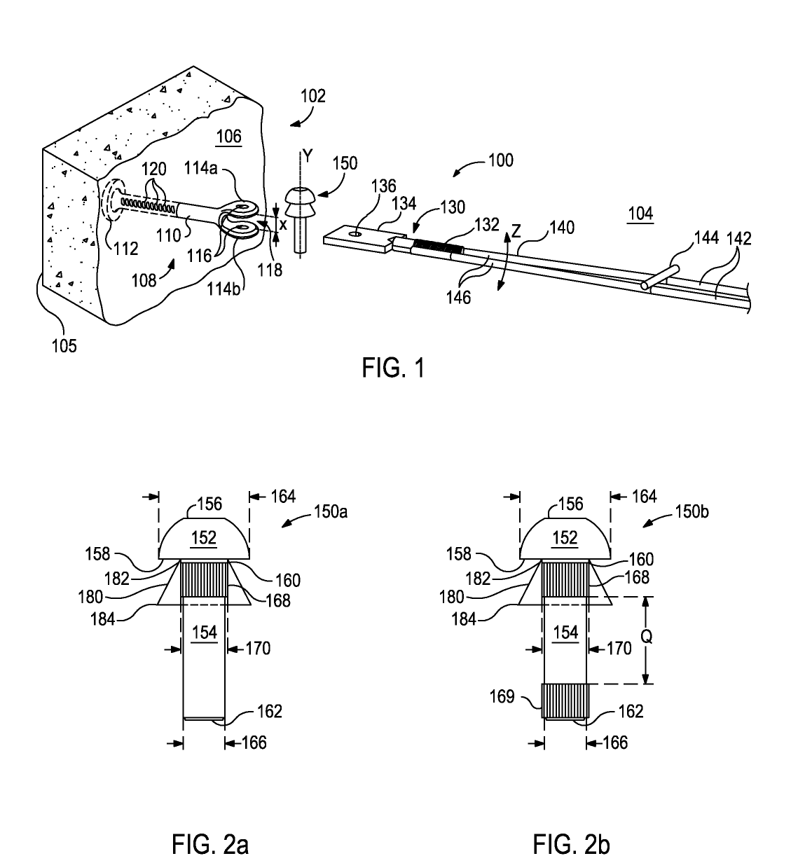

Referring to FIG. 1, illustrated is an exemplary soil reinforcing system 100 for securing a facing 102 to an earthen formation 104, according to one or more aspects of the disclosure. The facing 102 may be a precast concrete panel or, alternatively, a plurality of interlocking precast concrete modules or wall members that are assembled into an interlocking relationship. In other embodiments, the facing 102 is a uniform, unbroken expanse of concrete or the like which may be poured or assembled on site. The facing 102 defines an exposed face 105 and a back face 106. The exposed face 105 is usually a decorative architectural facing seen from outside the MSE structure, while the back face 106 is located within the MSE structure, adjacent the earthen formation 104.

Cast into the facing 102, or otherwise attached thereto, and protruding generally from the back face 106, is at least one exemplary facing anchor 108. In other embodiments, the facing anchor 108 may be mechanically-fastened to the back face 106, for example, using bolts or other mechanical fasteners. In yet other embodiments, the facing anchor 108 may be inserted into a hole drilled into the back face 106 and secured therein with epoxy, concrete, construction adhesive, combinations thereof, or the like.

It will be appreciated that the illustrated facing anchor 108 is merely exemplary and should not be limited to the embodiments shown herein, as other types of facing anchors are also contemplated without departing from the scope of the disclosure. Several exemplary embodiments of the facing anchor 108, and a range of variations thereof, are found in co-pending U.S. patent application Ser. No. 12/756,898, entitled “Retaining Wall Soil Reinforcing Connector and Method,” the contents of which are hereby incorporated by reference to the extent consistent with this disclosure.

The illustrated facing anchor 108 may be characterized as a dual-prong stud anchor, having an elongated shaft 110 terminating at a head 112 at one end and a pair of offset connection points or prongs 114a, 114b extending axially from the other end. The head 112 may be omitted from the shaft 110 in one or more embodiments without departing from the scope of the disclosure. Each prong 114a,b defines a centrally-disposed hole 116 and is offset by a distance X, thereby creating a gap 118 between the prongs 114a,b. The gap 118 provides a location for connecting a soil reinforcing element 140 to the facing anchor 108. A series of indentations or grooves 120 may be defined along the axial length of the shaft 110. The grooves 120 may help prevent removal of the facing anchor 108 from the facing 102 by providing a stronger bond and/or frictional engagement with the concrete, adhesive, epoxy, etc., within the facing 102.

The earthen formation 104 may encompass an MSE structure including a plurality of soil reinforcing elements 140 that extend horizontally into layers of backfill material. The soil reinforcing elements 140 serve as tensile resisting elements strategically-positioned in the backfill in a substantially horizontal alignment at spaced-apart relationships to one another against the compacted backfill material.

The exemplary soil reinforcing element 140 is a welded wire grid having a pair of longitudinal wires 142 that extend substantially parallel to each other. The longitudinal wires 142 are joined to a plurality of transverse wires 144 in a generally perpendicular fashion by welds at their intersections, thus forming a welded wire gridwork. In exemplary embodiments, the spacing between each longitudinal wire 142 may be about 2 in., while spacing between each transverse wire 144 may be about 6 in. As can be appreciated, however, the relative spacing and configuration may vary depending on the mixture of tensile force requirements that the reinforcing element 140 must resist.

In one or more embodiments, the lead ends 146 of the longitudinal wires 142 generally converge toward one another and are welded or otherwise attached to a connection stud 130. The connection stud 130 may have a stem 132 (first end) extending from a tab 134 (second end), where the lead ends 146 are coupled to the stem 132. The tab 134 may be a substantially planar plate that defines at least one centrally-located perforation or hole 136 defined therethrough. As with the facing anchor 108, it will be appreciated that the connection stud 130 is only exemplary and should not be limited to the embodiments shown and described herein. For example, several exemplary embodiments of the connection stud 130, and a range of variations thereof, are found in co-pending U.S. patent application Ser. No. 13/100,927, entitled “Retaining Wall Soil Reinforcing Connector and Method,” the contents of which are also hereby incorporated by reference to the extent consistent with this disclosure.

A drive pin mechanical fastener 150 is used to couple the facing anchor 108 to the connection stud 130. Referring to FIGS. 2A and 2B, illustrated are side views of exemplary mechanical fasteners 150a and 150b, according to one or more embodiments described. Each mechanical fastener 150a,b includes a head 152 coupled to or integral with a body 154. The head 152 includes a first, top surface 156 and a second, shoulder surface 158. The body 154 has a first end 160 coupled to the shoulder surface 158 and extends to a second end 162 distal the shoulder surface 158.

The body 154 is adapted to be inserted through the concentric holes 116 of each prong 114a,b, and simultaneously through the hole 136 defined in the tab 134 in order to couple the facing anchor 108 to the connection stud 130. A first series of seating teeth 168 may be disposed around or otherwise formed on the body 154 proximate its first end 160. The teeth 168 may be generally defined axially along the axial length of the body 154 and extend around the all or a portion of the circumference of the body 154. The teeth 168 may have an outer diameter 170 that is slightly greater than the outer circumference or diameter 166 of the body 154 and also slightly greater than the diameter of the holes 116 in the prongs 114a,b. Thus, as the body 154 is inserted or otherwise forced into the hole 116 of the first prong 114a, the teeth 168 provide an interference or friction fit with the prong 114a. Consequently, the mechanical fastener 150 is secured to the facing anchor 108, and the facing anchor 108 is secured to the connection stud 130.

As shown in FIG. 2B, a second series of seating teeth 169 (FIG. 2B) may be disposed about or otherwise formed on the body 154 a distance Q from the first series of teeth 168. The second series of teeth 169 may be substantially similar to the first series of teeth 168, and therefore will not be described in detail. The second series of teeth 169 form an interference or friction fit with the hole 116 in the second prong 114b to further assist in securing the mechanical fastener 150b to the facing anchor 108. Although the body 154 of either mechanical fastener 150a,b is depicted as having a circular cross-section, other cross-sectional shapes are also contemplated, and the term circumference used herein is used to describe the general distance around the outer surface of the body 154.

The shoulder surface 158 has a diameter 164 greater than the diameter 166 of the body 154 such that the fastener 150a,b is prevented from passing entirely through the holes 116. Accordingly, once the shoulder surface 158 engages the first prong 114a, the body 154 is prevented from any further advancement.

An elongate indicator shroud 180 is disposed at least partially around the body 154 and extends radially-outward from the first series of teeth 168. The indicator shroud 180 is made of a deformable or malleable material, such as, but not limited to, plastics or soft metals. A first end 182 of the indicator shroud 180 is coupled to or otherwise seated at the first end 160 of the body 154 and extends to a second end 184 in a generally frustoconical shape. Consequently, the diameter of the first end 182 of the indicator shroud 180 is generally smaller than the diameter of the second end 184 of the indicator shroud 180.

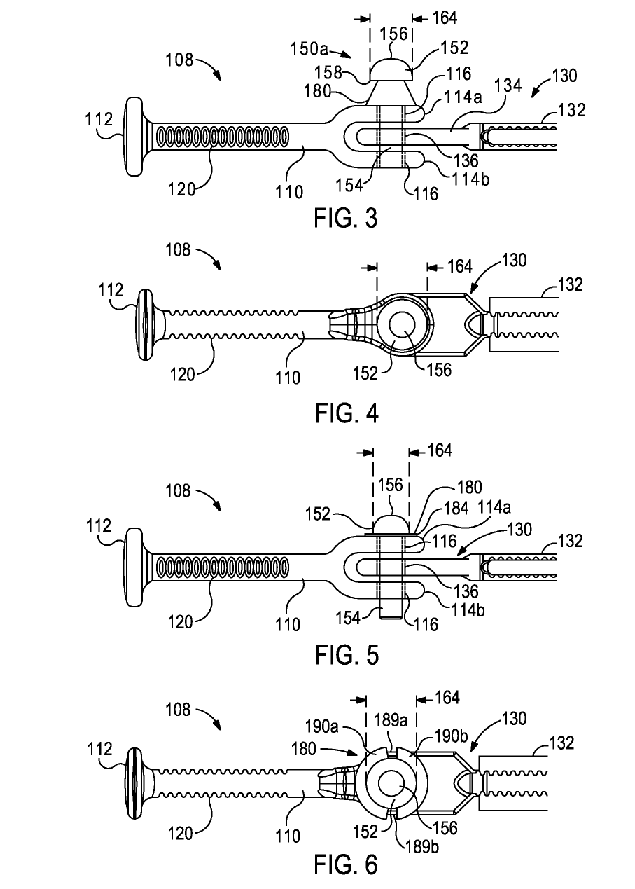

Referring now to FIGS. 3 and 4, illustrated are side and top views, respectively, of the first mechanical fastener 150a in a first, unengaged position with the connection stud 130 and the facing anchor 108, according to one or more embodiments described. As will be appreciated, the second mechanical fastener 150b could equally be illustrated without departing from the scope of the disclosure. As shown, the tab 134 of the connection stud 130 is positioned between the prongs 114a,b such that the hole 136 in the tab 134 is aligned with the holes 116 in the opposing prongs 114a,b. The body 154 of the mechanical fastener 150a is then inserted through the aligned holes 116, 136 and into the first, unengaged position, i.e., where the shoulder surface 158 of the fastener 150a is spaced from the first prong 114a. In one embodiment, the diameter of second end 184 of the indicator shroud 180 is less than or equal to the diameter 164 of the head 152, such that the indicator shroud 180 may not be visible from the top perspective, e.g., as from the vantage point of an installer or site worker.

FIGS. 5 and 6 illustrate side and top views, respectively, of the mechanical fastener 150a in its second, engaged position with the connection stud 130 and the facing anchor 108, according to one or more embodiments described. The second position is realized by driving the mechanical fastener 150a into the holes 116 such that the first series of teeth 168 engage the inner surface of the hole 116 of the first prong 114a. For example, the top surface 156 of the head 152 may be struck, such as with a hammer or another blunt object, to push, move, or otherwise force the mechanical fastener 150 into engagement such that the shoulder surface 158 of the head 152 is disposed adjacent the corresponding surface of the first prong 114a. Where the second fastener 150b (FIG. 2b) is used, driving the fastener 150b into the holes 116 also engages the second series of seating teeth 169 (FIG. 2) with the inner surface of the hole 116 defined in the second prong 114b.

Driving the fastener 150a into the holes 116 may generally flatten the indicator shroud 180 between the shoulder surface 158 of the mechanical fastener 150 and the first prong 114a. In at least one embodiment, the indicator shroud 180 may tear at one or more locations 189a and 189b, thereby exposing one or more portions 190a and 190b of the indicator shroud 180 which extend radially-outward from the head 152. The portions 190a,b of the indicator shroud 180 may be seen from above, such as from the vantage point of an installer or site worker. Consequently, the exposed portions 190a,b may provide a visual indicator that the mechanical fastener 150a is properly engaged, thereby allowing the installer or site worker to proceed to the next connection point.

Once coupled to the facing anchor 108, the connection stud 130 may be able to swivel or rotate about axis Y (FIG. 1) in a horizontal plane, and move vertically about the mechanical fastener 150 for the distance X (FIG. 1). The soil reinforcing element 140 (as coupled to the connection stud 130) may be allowed to swivel or rotate about axis Y in a horizontal plane Z (FIG. 1). To avoid obstructions, such as a drainage pipe, catch basin, bridge pile, bridge pier, or the like, the soil reinforcing element 140 may be pivoted about axis Y to any angle relative to the back face 106, thereby swiveling to a position in the backfill where no obstacle exists.

Moreover, the gap 118 defined between two prongs 114a,b may allow for a distance of settling of either the MSE structure or the soil reinforcing element 140 without the soil reinforcing element 140 binding on the facing 102. For instance, during settling the tab 134 may be able to shift or slide vertically about the mechanical fastener 150 the distance X, thereby compensating for a potential vertical drop of the soil reinforcing element 140 and preventing the concrete facing 102 from buckling. Varying designs of anchors 108 may be used that increase or decrease the distance X to compensate for potential settling or other MSE mechanical phenomena. Furthermore, it is not uncommon for concrete facings 102 to shift in reaction to MSE settling or thermal expansion/contraction. In instances where such movement occurs, the soil reinforcing elements 140 are capable of correspondingly swiveling about axis Y and shifting the vertical distance X to prevent misalignment, buckling, or damage to the concrete facing 102.

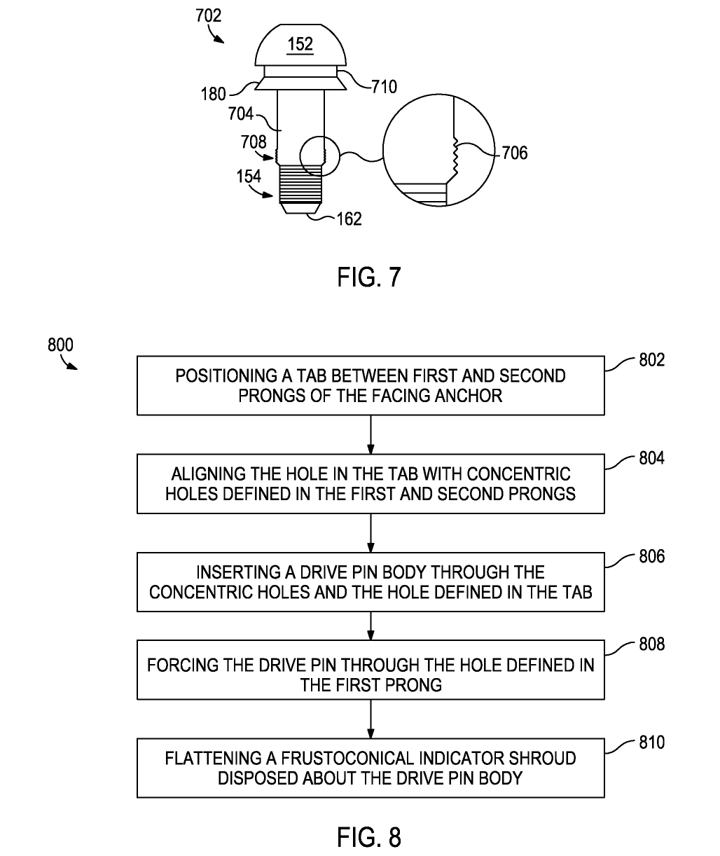

Referring now to FIG. 7, illustrated is a side view of another drive pin mechanical fastener 702, according to one or more embodiments disclosed. The fastener 702 may be somewhat similar to the previously described fasteners 150a,b discussed above with reference to FIGS. 2a,b, respectively. Accordingly, the fastener 702 may be best understood with reference to FIGS. 2a and 2b, where like numerals will be used to indicate like elements that will not be described again.

Unlike the fasteners 150a,b described above, the body 154 of the fastener 702 may be at least partially encased in an elongate sleeve 704. The sleeve 704 may be made from a variety of materials including, but not limited to, plastics, metals, or other flexible or semi-flexible materials. In other embodiments, the sleeve 704 forms an integral part of the fastener 702, such that the sleeve 704 and the fastener 702 are made of the same material in the same monolithic structure.

In one embodiment, the sleeve 704 is sized slightly larger than the holes 116 of the prongs 114a,b (FIG. 1) such that it will fit snugly or otherwise form an interference fit with each hole 116 as the fastener 702 is driven or forced into its engaged position with the anchor 108. In other embodiments, the sleeve 704 is sized to loosely fit into each hole 116, without departing from the scope of the disclosure. The sleeve 704 may also serve a dual purpose by further protecting the fastener 702 from the onset of corrosion.

A plurality of barbs or serrations 706 may be defined at a distal end 708 of the sleeve 704. The serrations 706 are deformable, but resilient, such that as the serrations 706 pass through the holes 116 they rebound and prevent the fastener 702 from reversing direction back through the holes 116. In one embodiment, the body 154 is also threaded at the second end 162 so that a nut (not shown) can be threaded thereon to secure the fastener against removal.

The fastener 702 may also include a lever point 710 defined adjacent the head 152, but above the indicator shroud 180. The lever point 710 may be sized larger than the holes 116 such that the fastener 702 is prevented from passing all the way through the holes 116 by the lever point 710. As the fastener 702 is driven through the holes 116, the indicator shroud 180 operates as generally described above to indicate when the fastener 702 is properly installed. The lever point 710 extends above the flattened indicator shroud 180 in the engaged position and provides a location where the fastener 702 may be removed from the anchor 108. Specifically, the lever point 710 may provide a gap between the head 152 and the first prong 114a in the engaged position such that a type of prying device, such as a pry bar or the claw of a hammer, may be inserted into the gap in order to lever the fastener 702 from its engaged position. It will be appreciated that the lever point 710 may also be used or otherwise defined on the mechanical fasteners 150a,b described above.

Referring now to FIG. 8, illustrated is a flowchart of a method 800 for securing a soil reinforcing element to a facing anchor, according to one or more embodiments. The method 800 may include positioning a tab between first and second prongs of the facing anchor, as at 802. The tab can be coupled to the soil reinforcing element and have a hole centrally-defined therein. The hole defined in the tab may be aligned with concentric holes defined in the first and second prongs, as at 804. The method 800 may further include inserting a drive pin body through the concentric holes of the first and second prongs and simultaneously through the hole in the tab, as at 806. The drive pin body extends from a head and has a first series of teeth formed thereon adjacent the head. The drive pin body may then be forced through the hole defined in the first prong, as at 808, such that the first series of teeth form an interference fit therein. The method 800 may further include flattening a frustoconical indicator shroud disposed about the drive pin body, as at 810. The indicator shroud is disposed adjacent the head and is flattened such that portions of the frustoconical indicator shroud are exposed radially-outward from the head and thereby provide a visual indication that the drive pin is properly secured.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A drive pin mechanical fastener, comprising:
an elongate body extending from a head; and
an indicator shroud having a first end and a second end, the first end being disposed about the elongate body proximate the head and the second end extending away from the head, the indicator shroud being movable from a first position, where the indicator shroud is frustoconical, to a second position, where the indicator shroud is flattened.

2. The drive pin mechanical fastener of claim 1, wherein the head comprises a top surface and a shoulder surface, and the indicator shroud engages the shoulder surface in the second position.

3. The drive pin mechanical fastener of claim 1, further comprising a sleeve at least partially encasing the elongate body.

4. The drive pin mechanical fastener of claim 3, further comprising a plurality of serrations defined at a distal end of the sleeve.

5. The drive pin mechanical fastener of claim 1, further comprising a lever point defined between the head and the indicator shroud, the lever point having a diameter greater than a diameter of the elongate body.

6. The drive pin mechanical fastener of claim 1, further comprising a first series of teeth formed on the elongate body proximate the head.

7. The drive pin mechanical fastener of claim 6, further comprising a second series of teeth formed on the elongate body distal the head, wherein the first and second series of teeth extend radially outward from a diameter of the elongate body.

8. A connection assembly for a soil reinforcing element, comprising:
a facing anchor having first and second offset prongs, each prong having a hole defined therein;
a connection stud coupled to the soil reinforcing element and having a tab that defines a tab hole therein, the tab being positioned between the first and second prongs such that the tab hole is concentrically-aligned with the holes in the first and second prongs;
a mechanical fastener having an elongate body extending from a head and through the holes defined in the prongs and the tab hole; and
an indicator shroud having a first end and a second end, the first end being disposed about the body proximate the head of the mechanical fastener and the second end extending away from the head, wherein the mechanical fastener is configured to move from a first position, where the indicator shroud is frustoconical, to a second position, where the indicator shroud is flattened and extends radially-outward from the head such that the indicator shroud as flattened is visible from a top perspective.

9. The connection assembly of claim 8, wherein the head comprises a top surface and a shoulder surface, and the indicator shroud engages the shoulder surface in the second position.

10. The connection assembly of claim 8, further comprising a sleeve at least partially encasing the elongate body and having a plurality of serrations defined at a distal end of the sleeve.

11. The connection assembly of claim 10, wherein the sleeve is sized to form an interference fit with the holes defined in the first and second prongs.

12. The connection assembly of claim 10, wherein the plurality of serrations are deformable, but resilient, such that the plurality of serrations passes through the holes defined in the first and second prongs and rebounds to prevent the mechanical fastener from removal from the facing anchor.

13. The connection assembly of claim 10, further comprising a plurality of threads defined on a distal end of the elongate body, the plurality of threads being configured to receive a nut that secures the mechanical fastener against removal from the facing anchor.

14. The connection assembly of claim 9, wherein the shoulder surface is positioned adjacent a corresponding surface of the first prong when the mechanical fastener is in the second position.

15. The connection assembly of claim 14, wherein the indicator shroud is flattened and interposes the shoulder surface and the corresponding surface of the first prong when the mechanical fastener is in the second position.

16. The connection assembly of claim 8, further comprising a first series of teeth formed on the elongate body proximate the head, wherein the first series of teeth forms an interference fit with the first prong of the facing anchor to secure the mechanical fastener in the second position.

17. The connection assembly of claim 16, further comprising a second series of teeth formed on the elongate body distal the head, wherein the second series of teeth forms an interference fit with the second prong of the facing anchor to further secure the mechanical fastener in the second position.

18. A method of securing a soil reinforcing element to a facing anchor, comprising:
positioning a tab between first and second prongs of the facing anchor, the tab being coupled to the soil reinforcing element and having a tab hole defined therein;
aligning the tab hole with concentric holes defined in the first and second prongs;
inserting a drive pin body through the concentric holes of the first and second prongs and simultaneously through the tab hole, the drive pin body extending from a head and having a first series of teeth formed thereon adjacent the head;
forcing the drive pin body through the hole defined in the first prong such that the first series of teeth form an interference fit therein; and
flattening an indicator shroud disposed about the drive pin body adjacent the head such that portions of the frustoconical indicator shroud are exposed radially-outward from the head and thereby provide a visual indication that the drive pin is properly secured.

19. The method of claim 18, wherein forcing the drive pin body through the hole defined in the first prong further comprises striking a top surface of the head with a hammer.

20. The method of claim 18, wherein the drive pin body further defines a second series of teeth formed thereon distal the head and the method further comprises forcing the drive pin body through the hole defined in the second prong such that the second series of teeth form an interference fit therein.

21. The method of claim 18, wherein the drive pin body is at least partially encased in a sleeve and the method further comprises forcing the drive pin body through the concentric holes defined in the first and second prongs such that the sleeve forms an interference fit in each concentric hole.

22. A drive pin mechanical fastener, comprising:
an elongate body extending from a head;
a sleeve at least partially encasing the elongate body; and
a plurality of serrations defined at a distal end of the sleeve, wherein the plurality of serrations are deformable, but resilient, such that the plurality of serrations are adapted to pass through one or more holes defined in a facing anchor and rebound to prevent the mechanical fastener from removal from the facing anchor.

23. The drive pin of claim 22, further comprising an indicator shroud having a first end and a second end, the first end being disposed about the elongate body proximate the head and the second end extending away from the head, the indicator shroud being movable from a first position, where the indicator shroud is frustoconical, to a second position, where the indicator shroud is flattened.

24. A drive pin mechanical fastener, comprising:
an elongate body extending from a head; and
a first series of teeth formed on the elongate body proximate the head and extending at least partially around a circumference of the elongate body, the first series of teeth having an outer diameter greater than a diameter of the elongate body and extending axially along an axial length of the body.

25. The drive pin mechanical fastener of claim 24, further comprising a second series of teeth formed on the elongate body distal the head and extending at least partially around the circumference of the elongate body, the second series of teeth having an outer diameter greater than the diameter of the elongate body and extending axially along the axial length of the body.

26. The drive pin of claim 24, further comprising an indicator shroud having a first end and a second end, the first end being disposed about the elongate body proximate the head and the second end extending away from the head, the indicator shroud being movable from a first position, where the indicator shroud is frustoconical, to a second position, where the indicator shroud is flattened.
